(19) United States
(12) Patent Application Publication
(10) Pub. No.: US 2016/0034650 A1
(43) Pub. Date: Feb. 4, 2016

(54) Vaccine Logistics Systems and Methods

(71) Applicant: VaxCare Corporation, Orlando, FL (US)

(72) Inventors: Casey DeLoach, Orlando, FL (US); Evan Landis, Orlando, FL (US); Paul Loht, Orlando, FL (US)

(21) Appl. No.: 14/449,953

(22) Filed: Aug. 1, 2014

(51) Int. Cl. G06F 19/00

(52) U.S. Cl. CPC G06F 19/328

(57) ABSTRACT

According to the invention, a system for determining whether to guarantee payment to a health care provider for administering a vaccination to a patient is disclosed. The system may include a computer which receives, from a provider interface, a check-in message which includes biographical information of the patient and insurance information of the patient. The computer may also determine, based on the biographical information, a vaccination that the patient should receive. The computer may further determine via a rules engine, and based on the insurance information, a likelihood that an insurance claim for the vaccination would be approved. The computer may additionally determine, based on the determined likelihood, whether to guarantee payment to the health care provider for administering the vaccination. The computer may moreover send an eligibility message to the provider interface, where the eligibility message includes an indication of whether payment for administering the vaccination is guaranteed.

### BACKGROUND OF THE INVENTION

This invention relates generally to the healthcare industry. More specifically the invention relates to systems and methods for assisting in efficient delivery of vaccinations to patients by providers and payers (i.e., insurance entities).

Vaccinations provided by health care providers for individuals are often available to individuals at no cost, or at least reduced cost, via reimbursement through health insurance and government programs. However, because of the associated administrative and logistical costs involved with maintaining inventories of vaccines, and submitting claims for reimbursement from payers, most health care providers are inefficient at delivering vaccinations to patients.

Most importantly, insurance companies, government programs, and other payers do not provide guarantees of payment to a health care provider for any service provided to a patient, including administration of a vaccine. This is true even when all indications are that an insurance company or other payer is actively insuring a patient, and the terms of that coverage by all interpretations include coverage for such service or vaccines. Payment is made or not made to a health care provider after a claim for such services is submitted to the payer, but no guarantees prior to such payment are made in the industry.

The aforementioned inefficiencies have greater societal costs as well. Micro level inefficiencies of individual providers can cause macro level problems such as reduced immunization rates and loss of productivity associated therewith, and increased overall health care costs otherwise avoided by higher immunization rates. Embodiments of the invention provide solutions to these and other problems.

### BRIEF DESCRIPTION OF THE INVENTION

In one embodiment, a system for determining whether to guarantee payment to a health care provider for administering at least one vaccination to a patient is provided. The system may include at least one host computer which receives a check-in message from a provider interface, where the check-in message includes biographical information of the patient and insurance information of the patient. The host computer may also determine via a rules engine, and based at least in part on the biographical information, a first vaccination that the patient should receive. The host computer may further determine, based at least in part on the insurance information, a likelihood that an insurance claim for administration of the first vaccination would be approved. The host computer may additionally determine, based at least in part on the likelihood that the insurance claim for administration of the first vaccination would be approved, whether to guarantee payment to the health care provider for administering the first vaccination. The host computer may moreover send an eligibility message to the provider interface, where the eligibility message includes an indication of whether payment for administering the first vaccination is guaranteed for the health care provider.

In another embodiment, a method for determining whether to guarantee payment to a health care provider for administering at least one vaccination to a patient is provided. The method may include receiving a check-in message from a provider interface, where the check-in message includes biographical information of the patient and insurance information of the patient. The method may also include determining via a rules engine, and based at least in part on the biographical information, a first vaccination that the patient should receive. The method may further include determining, based at least in part on the insurance information, a likelihood that an insurance claim for administration of the first vaccination would be approved. The method may additionally include determining, based at least in part on the likelihood that the insurance claim for administration of the first vaccination would be approved, whether to guarantee payment to the health care provider for administering the first vaccination, and an amount of the guarantee. The method may moreover include sending an eligibility message to the provider interface, where the eligibility message includes an indication of whether payment for administering the first vaccination is guaranteed for the health care provider, and the amount of the guarantee. The method may furthermore include receiving a check-out message from the provider interface, where the check-out message includes an indication that the health care provider administered the first vaccine to the patient. The method may also include causing a payment to the health care provider in the amount of the guarantee to be initiated based at least in part on the check-out message being received.

In another embodiment, a non-transitory machine readable medium is provided. The non-transitory machine readable medium may have instructions stored thereon for determining whether to guarantee payment to a health care provider for administering at least one vaccination to a patient. The instructions may be executable by a processor to receive a check-in message from a provider interface, where the check-in message includes biographical information of the patient and insurance information of the patient. The instructions may also be executable to determine via a rules engine, and based at least in part on the biographical information, a first vaccination that the patient should receive. The instructions may further be executable to determine, based at least in part on the insurance information, a likelihood that an insurance claim for administration of the first vaccination would be approved. The instructions may additionally be executable to determine, based at least in part on the likelihood that the insurance claim for administration of the first vaccination would be approved, whether to guarantee payment to the health care provider for administering the first vaccination. The instructions may moreover be executable to send an eligibility message to the provider interface, where the eligibility message includes an indication of whether payment for administering the first vaccination is guaranteed for the health care provider. The instructions may furthermore be executable to receive a check-out message from the provider interface, where the check-out message includes an indication that the health care provider administered the first vaccine to the patient. The method may also be executable to update a stock of a first vaccine corresponding with the first vaccination in a virtual inventory of the health care provider based at least in part on the check-out message.

### BRIEF DESCRIPTION OF THE DRAWINGS

The present invention is described in conjunction with the appended figures:

FIG. 1 is a block diagram of one embodiment of the invention for guaranteeing payment to a health care provider for administering at least one vaccination to a patient;

FIG. 2 is a block diagram of a provider location as shown in FIG. 1;

FIG. 3 is a block diagram of a method of the invention performed by the systems of FIG. 1; and

FIG. 4 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of example embodiments will provide those skilled in the art with an enabling description for implementing these and other implicit embodiments. Various changes may be made in the function and arrangement of elements without departing from the spirit and scope of the invention as set forth in the appended claims. For example, any specific detail discussed with regard to one embodiment herein may or may not be present in all possible variations of that embodiment, and may or may not be present in all possible variations of other embodiments discussed herein.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In various embodiments of the invention, systems and methods for determining whether to guarantee payment to a health care provider for administering at least one vaccination to a patient are provided. Machine readable mediums (for example, hard drives or other computer readable devices) may also be provided which have instructions stored thereon for implementing the methods discussed herein.

Additional functions and benefits beyond guaranteeing payment to health care providers for administering immunizations may also be provided by the systems and methods discussed herein. Merely by way of example, inventories of vaccines kept by health care providers may be better managed, reducing the instances where vaccines are unavailable or go unused and expire; and immunization rates may be increased, both population wide, and for a health care provider's particular group of patients.

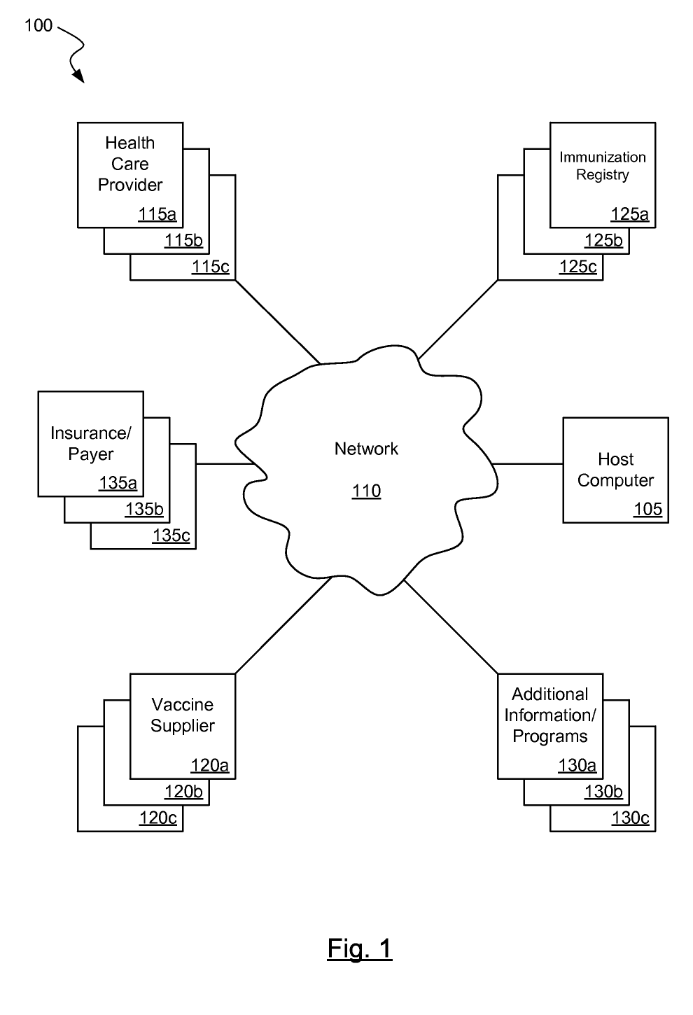

With reference to FIG. 1, one possible system 100 may include a host computer 105 which is in communication with various computer systems of other entities via network 110. Merely by way of example, in some embodiments, network 110 may be the Internet. Health care providers 115 may include doctor offices, hospitals, clinics, etc. where health professionals vaccinate patients, and potentially perform other services. Vaccine suppliers 120 may provide and/or sell vaccines to health care providers 115. Immunization registries 125 may have databases of individuals, and of when, where, and what vaccines they have received, and also what vaccines they should receive to be up to date on recommended and/or required vaccinations.

Additional sources of information and/or programs 130 may also be in communication with host computer 105, and may provide information regarding vaccines, eligibility for special vaccination programs, healthcare alerts, etc. Additional sources of information and/or programs 130 may include, merely by way of example, information provided by the Food and Drug Administration (the “FDA”) or the Centers for Disease Control and Prevention (the “CDC”). Finally, insurance companies and other payers 135 of medical reimbursement claims may also be in communication with host computer (other payers may include Medicare, Medicaid, special programs, etc.). These companies and other payers 135 may issue reimbursements for qualified vaccinations to qualified patients upon request and satisfaction of other conditions.

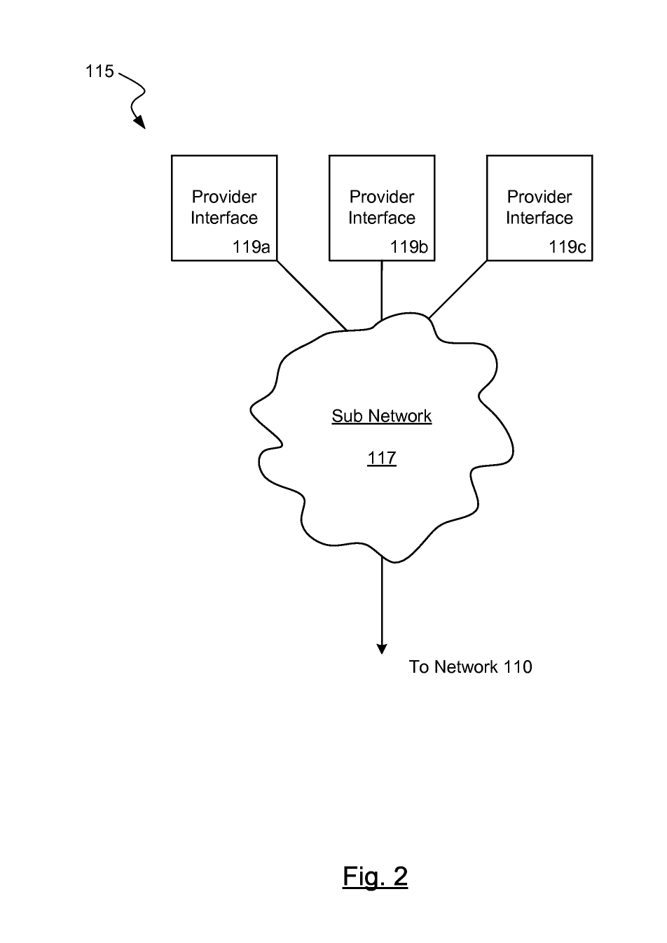

With reference to FIG. 2, a health care provider 115 location is shown in greater detail. At each health care provider 115, a sub network 117 connects one or more provider interfaces 119 to network 110 (and consequently host computer 105). While any number of provider interfaces 119 may be present at a given health care provider 115 location, in some embodiments, a front desk or reception area of health care provider 115 may have a first interface 119a, a patient treatment and/or vaccine storage area may have a second interface 119b, and an office location may have a third interface 119c. Merely by way of example, each interface 119 may be the same or different mobile computing device, a tablet computer, a notebook computer, a laptop computer, a desktop computer, or other device.

When a patient checks in at health care provider 115, the patient may be greeted by an agent of health care provider 115 which collects biographical and insurance information from the patent, and inputs the same into interface 119a. In some embodiments, the patient may do this themselves. Biographical information which may be collected and input into interface 119a may include name, social security number, address, birthdate, etc. Insurance information which may be collected and input into interface 119a may include insurance company name, group number, policy number, etc. Additional medical information may also be submitted by the patient or the agent of health care provider 115 such as the current and former state of health of the patient, vaccination history, as well as prior health related incidents (injuries, surgeries, diagnoses, etc.). More information may be submitted on initial visits than on later visits in order to bring electronic records up to date.

Once all information is input into interface 119a, any portion or all of the information may be transmitted as a check-in message to host computer 105 via sub network 117 and network 110. Host computer 105 may receive the check-in message, and determine, based on at least some of the information, one or more vaccines that the patient should receive. The one or more vaccines that the patient should receive may include a first vaccine, a second vaccine, a third vaccine, etc. Each of these vaccines may be a particular type of vaccine intended to cause the patient's immune system to better respond to a particular antigen of a pathogen which the patient may later encounter. In some embodiments, the determination may be based solely on the biographical information, while in other embodiments information may be obtained from immunization registries 125, and/or additional sources of information and/or programs 130 as discussed above (for example, FDA and/or CDC guidelines/licensure/standards). But in other embodiments, other sources of information may also contribute to the determination. By way of example, in one embodiment, host computer 105 may have a set of conditions by which biographical information of the patient may be judged to determine which vaccinations the patient should receive (i.e., based on their age, health status, previous immunization history, etc.). In yet a more specific example, host computer 105 may determine which types of vaccines a specific patient should receive based on their age and current FDA/CDC guidelines. The types of vaccines a patient should receive may include zero, one, two, or more, individual specific vaccines. The types or groups of vaccines a patient a patient should receive may thus vary in this embodiment based on their age and the current FDA/CDC guidelines.

Host computer 105 may then determine via a rules engine, and based at least in part on the insurance information of the patient, a likelihood that an insurance claim to the appropriate payer 135 for administration of each of the vaccinations would be approved. Essentially this is a prediction as to whether payer 135, will reimburse a provider 115 who administers the vaccination to the particular patient. Host computer 105 may also determine how much payer 135 is likely to reimburse for the vaccination. Host computer 105 may further determine, from the rules engine and the check-in message, an amount the patient is responsible for, if any (i.e., any amount not predicted to be covered by payer 135, potentially including co-pays specified thereby). In this manner, host computer 105 can determine whether it can make administration of a vaccine “risk free” for provider 115.

In many embodiments, host computer 105 may, prior to making a determination via the rules engine, determine whether the patient has active insurance coverage. This may be done by host computer 105, or other system, sending a request to confirm active insurance coverage to an insurance company system or other payer system 135 associated with the insurance information received from the patient. Once a response is received from the insurance company system or other payer system 135, this information can also be input into the rules engine to assist in determining the likelihood that the insurance claim for administration of each of the vaccinations would be approved. While lack of active insurance coverage will usually result in a determination by the rules engine that the insurance company or payer will not approve a claim, the presence of active insurance coverage may only be one prerequisite to a determination by the rules engine that a claim will be approved.

The rules engine may include a variety of data and conditions for determining the likelihood of reimbursement and/or the amount of the reimbursement. While some information may be included in the rules engine which is predefined, or obtained on-demand from databases or other sources of information and/or programs 130 (for example, the FDA and/or the CDC), such as specific terms of reimbursement for different vaccinations of different insurance/payer 135 programs under which patients fall, or recommendations by the FDA and/or the CDC, dynamic historical data from previous submission of claims by host computer 105 may also be included. The dynamic historical data of what claims have, and have not been, approved for the same and different patients having particular biographical and medical history may be analyzed by the rules engine in an iterative basis as new historical information comes available to determine the likelihood that a potential new claim for the patient having the same, similar, and/or different characteristics would be approved, and for how much.

Other information such as past payment history of the patient may also be employed by the rules engine to determine the likelihood of reimbursement and/or the amount of the reimbursement. For example, the creditworthiness of the patient, perhaps as indicated by a credit report or credit score obtained from a credit bureau or reporting agency such as Equifax™, Experian™, or TransUnion™ may be used to determine the likelihood of reimbursement and/or the amount of reimbursement. In another example, past payment history for amounts due by the patient or other responsible parties may be used to determine the likelihood of reimbursement and/or the amount of reimbursement. More specifically, the patient may not have paid for amounts due by them for co-pays or other non-covered costs of past vaccinations and/or other medical procedures, thereby affecting the determination.

The rules engine may also include cost information for various vaccines, on a supplier 120 and destination-provider 115 basis, so that the determined likely reimbursement can be compared to the cost of actually delivering the vaccine to the given provider 115. Different algorithms may combine all of the above factors, as well as additional factors, to determine whether or not to guarantee to provider 115 that if provider 115 administers the vaccination to the patient, provider 115 will be paid for such administration.

Upon determining if a guarantee will or will not be provided, and for how much, as well as the amount of patient responsibility, host computer 105 may send an eligibility message to provider interface 119 including such information. Interface 119 may then display to provider 115 the resultant determinations of whether there is a guarantee and potentially for what financial amount. Provider 115 will then administer whichever vaccines they so elect, but will do so knowing that the vaccines identified by interface 119 as being guaranteed will be paid for by host computer 105 (or its operating entity). In this manner, a guarantee may be provided to provider 115

After completion of the vaccination administration(s) for the particular patient, and perhaps after multiple patients, have been processed as described above, provider 115 may send a check-out message to host computer 105 via interface 119. The check-out message may include an indication that health care provider 115 administered particular vaccines previously recommended by the eligibility message for the patient(s). Host computer 105 may then cause a payment to the health care provider 115 in the amount of the guarantee to be initiated based at least in part on the contents of the check-out message (i.e., to pay for those vaccines which were guaranteed for the particular amounts).

During or after payment to provider 115 occurs, host computer 105 may format and send electronic and/or paper claims to payers 135 on either an individual patient vaccine/payer 135 basis, or in some batch grouping thereof. The claims may be based on some or all of the information contained in the check-in message, the eligibility message, and/or the check-out message. When a response and/or payment is received by host computer 105 (or its operating entity), the rules engine is updated to reflect the result of the claim submission.

In some embodiments, the time to receive payment from payer 135 after submission of a claim may also be input into the rules engine and affect determinations thereof in later instances. Additionally, in some embodiments, any determined amount of patient responsibility, as modified by the results of submission of the claim to payer 135 (i.e., remaining patient responsibility), may be used to update the rules engine. Furthermore, the patient may automatically be charged for such amount by host computer 105 (i.e., if prior approval was obtained), or billed. In some embodiments host computer 105 or its operator may not cover the remaining patient responsibility, and direct payment directly to the proper payee (i.e., provider 115), while in other embodiments, host computer 105 or its operator may cover the remaining patient responsibility and be paid directly by the patient.

In some embodiments, receipt of the check-out message by host computer 105 may also cause a stock of vaccines in a virtual inventory of the particular provider 115 to be updated. In this manner, host computer 105 can continually update the known amount of stock of vaccines at each provider 115. Once host computer 105 determines that the virtual inventory of a provider 115 is at or below a certain predefined threshold, an order may be placed by host computer 105 to vaccine supplier 120. Host computer 105 may be able to determine which supplier 120 is the most economical and efficient for supplying the particular provider 115 in need of additional vaccine. Host computer 105 may also model vaccine usage at a particular provider 115 to predict ahead of time when additional vaccines should be ordered so that a supply never drops below a predefined threshold. Such a prediction could be based on historical usage of the vaccine, the current time or of the year (i.e., flu season, etc.), and the total number of patients under the care of a particular provider 115.

In some embodiments, host computer 105, and/or the entity operating host computer 105, may provide some or all vaccines stored and administered by provider 115 so long as they adhere to the a given set of terms governing the use of system 100. This may include providing for all shipping and other costs associated with providing the vaccines to provider 115. In some embodiments, both “risk free” and non-“risk free” vaccines may be inventoried/stocked/provided by host computer 105, and/or the entity operating host computer 105. Provider 115 may then reimburse the entity operating host computer 105 for those vaccines which are administered without a guarantee from host computer 105.

In order to determine the total number of patients being cared for by a particular provider 115, a local or remote (i.e., at provider 115) database of patients may be accessed. In some embodiments, host computer 105 may be able to determine, on a regular recurring basis, prior to an inquiry being received, that certain patients should receive certain vaccines, and the cost to the patients, if any, based on their associated payer 135 information. Once such determinations are made, messages may be sent by host computer 105 to such patients via email, short message service (SMS), phone, or other means informing them of which provider 115 can provide the vaccines to them. Host computer 105 may also access immunization registries 125 and additional information/programs 130 to determine what individuals may be eligible for free or reduced cost vaccinations and inform them accordingly.

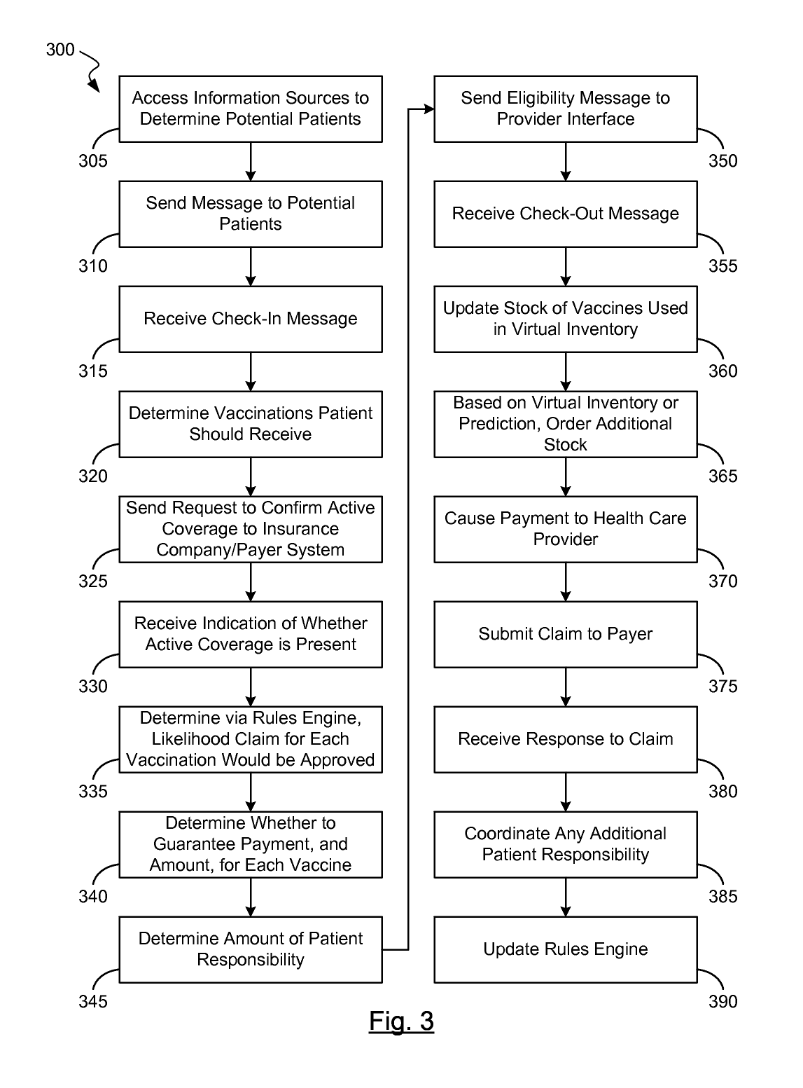

FIG. 3 shows a block diagram 300 of the above described methods. At block 305, information sources such as provider 115 patient databases, insurance/payer 135 databases, immunization registries 125, and additional information/programs 130 are accessed by host computer 105 to determine potential patients eligible for vaccinations. At block 310, messages are sent to each of the identified potential patients.

At block 315, a check-in message is receive by host computer 105 from provider interface 119. The check-in message potentially includes biographical and insurance information about the patient checking in (who may or may not have visited provider 115 because of a message received from host computer 105). At block 320, host computer 105 determines what vaccinations the patient should receive, possibly based on the biographical information and information from other sources.

At block 325, host computer 105 or other system sends a request to an insurance company or other payer system to verify or confirm that the patient has active insurance coverage. At block 330, host computer 105 or other system receives a response to the request to verify or confirm active coverage.

At block 335, host computer 105, via the rules engine, determines the likelihood that a claim made to an associated insurance or other payer 135 entity would be approved. At block 340, based on the determined likelihood of reimbursement, host computer 105 determines whether to guarantee each vaccination, and for how much. At block 345, any patient responsibility is also determined.

At block 350, an eligibility message is sent to provider interface 119 which includes at least all or some of which vaccines are guaranteed to be paid for by the operator of host computer 105, for how much, and which vaccines payment is not guaranteed. At block 355, host computer 105 receives a check-out message indicating which vaccines were administered to the patient.

The check-out message may be transmitted from the provider 115 or provider interface 119 in any number of ways. For example, the check-out message may sent via a web interface on provider interface 119 in a reception or office area of provider 115, via a paper fax from provider 115 to an entity operating host computer 105 which is thereafter manually or automatically processed into host computer 105, and/or a provider interface 119 in proximity to the inventory of vaccines and/or patient treatment area. Merely by way of example, as a vaccine is pulled from stock for administration to a patient, a barcode or other information on the vaccine container may be scanned by a provider interface 119 at the storage location. Scanning may cause a check-out message indicating the scanned vaccine was administered to automatically be sent to host computer 105. Other information such as patient biographical information (i.e., name, birthdate, social security number, insurance information) may also be transmitted in check-out message, as may have been acquired previously during the check-in process, or again at the provider interface 119 during administration (i.e, for verification purposes). The check-out message may assist in allowing host computer 105 to ensure that an insurance/payer claim is submitted in a timely manner after administration of the vaccine, as required by the relevant insurance/payer.

At block 360, stock of the administered vaccines is updated in the virtual inventory for provider 115. In some embodiments, and as discussed above, administration of vaccines to the patient may involve scanning a barcode or other information from the vaccine container or delivery device as the vaccine is pulled from stock in order to assist in maintaining the virtual inventory. At block 365, based on the virtual inventory, or on a prediction of future inventory levels, an order is placed to vaccine supplier 120 for delivery to the appropriate provider 115.

At block 370, host computer 105 causes a payment in the amount guaranteed for vaccines administered to be made to provider 115. At block 375, a claim is submitted to payer 135. At block 380, a response to the claim is received by host computer 105. At block 385, if any patient responsibility remains, the patient and/or provider 115 are informed and/or payment collected. At block 390, the rules engine is updated to reflect the resolution of the claim in light of what the rules engine predicted so that future determinations of likelihood of payment by payer 135 are more likely to be correct.

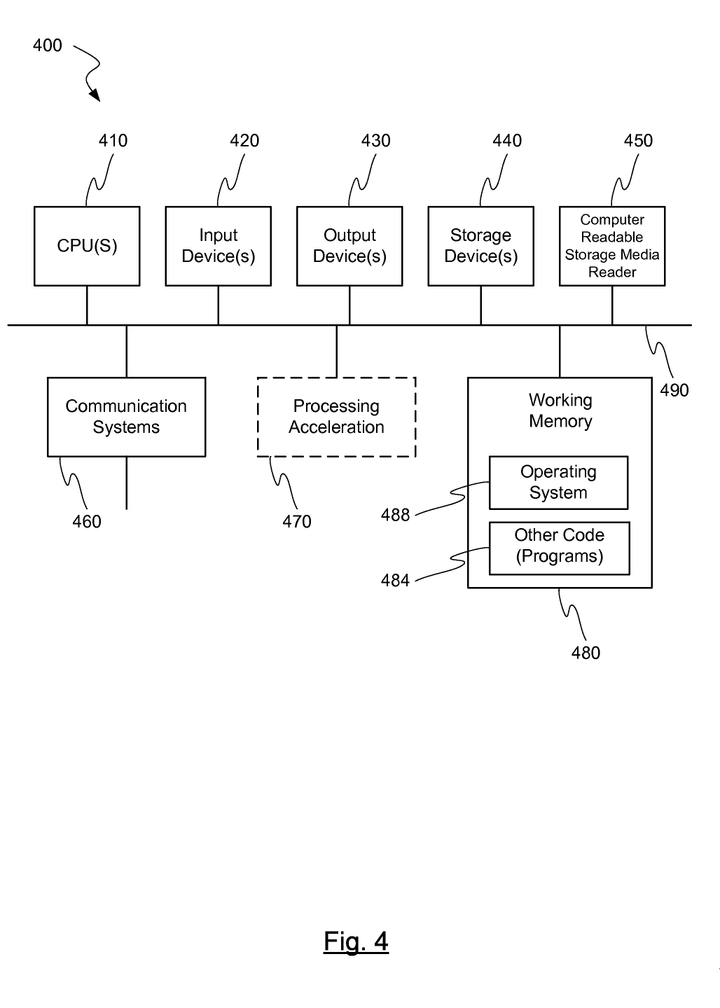

FIG. 4 is a block diagram illustrating an exemplary computer system 400 in which embodiments of the present invention may be implemented. This example illustrates a computer system 400 such as may be used, in whole, in part, or with various modifications, to provide the functions of host computer 105, network 110, provider interface 119, and/or other components of the invention such as those discussed above. For example, various functions of host computer 105 may be controlled by the computer system 400, including, merely by way of example, receiving check-in and check-out messages, determining vaccinations that patients should receive, determining likelihood of reimbursement for vaccinations, determining whether to guarantee payment for vaccinations, etc.

The computer system 400 is shown comprising hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). The computer system 400 may also include one or more storage device 440. By way of example, storage device(s) 440 may be disk drives, optical storage devices, solid-state storage device such as a random access memory (“RAM”) and/or a read-only memory (“ROM”), which can be programmable, flash-updateable and/or the like.

The computer system 400 may additionally include a computer-readable storage media reader 450, a communications system 460 (e.g., a modem, a network card (wireless or wired), an infra-red communication device, Bluetooth™ device, cellular communication device, etc.), and working memory 480, which may include RAM and ROM devices as described above. In some embodiments, the computer system 400 may also include a processing acceleration unit 470, which can include a digital signal processor, a special-purpose processor and/or the like.

The computer-readable storage media reader 450 can further be connected to a computer-readable storage medium, together (and, optionally, in combination with storage device(s) 440) comprehensively representing remote, local, fixed, and/or removable storage devices plus storage media for temporarily and/or more permanently containing computer-readable information. The communications system 460 may permit data to be exchanged with a network, system, computer and/or other component described above.

The computer system 400 may also include software elements, shown as being currently located within a working memory 480, including an operating system 484 and/or other code 488. It should be appreciated that alternate embodiments of a computer system 400 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 400 may include code 488 for implementing any or all of the function of the various elements of the architecture as described herein. For example, software, stored on and/or executed by a computer system such as system 400, can provide the functions of host computer 105, network 110, provider interface 119, and/or other components of the invention such as those discussed above. Methods implementable by software on some of these components have been discussed above in more detail.

A number of variations and modifications of the invention can also be used within the scope of the invention. For example, the provision of other medical supplies such as medications and service, in the place of vaccinations, could also be accomplished using the systems and methods discussed herein. Furthermore, interfaces 119 provided at the point of vaccine or other medicine storage could also monitor and/or control the security and/or conditions under which such vaccines or medicines are stored. Tablets or other computing devices could be used at such locations within a provider 115 location could assist in inventory and storage of vaccines and medicine by monitoring and controlling locks, temperature, and/or dispensing mechanisms, as well as storing/transmitting information related to conditions and or events involving the storage of vaccines. The tablets or other computing devices at the point of vaccine or other medicine storage could also cause automatic check-out messages, as discussed herein, to be sent to host computer 105.

The invention has now been described in detail for the purposes of clarity and understanding. However, it will be appreciated that certain changes and modifications may be practiced within the scope of the appended claims.

1. A system for determining whether to guarantee payment to a health care provider for administering at least one vaccination to a patient, wherein the system comprises:
at least one host computer for:
receiving a check-in message from a provider interface, wherein the check-in message comprises:
biographical information of the patient; and
insurance information of the patient;
determining, based at least in part on the biographical information, a first vaccination that the patient should receive;
determining via a rules engine, and based at least in part on the insurance information, a likelihood that an insurance claim for administration of the first vaccination would be approved, wherein determining via the rules engine the likelihood that the insurance claim for administration of the first vaccine would be approved comprises:
determining at least one characteristic of previously submitted insurance claims which were approved, at least in part, for vaccinations of individuals other than the patient;
determining at least one characteristic of previously submitted insurance claims which were denied for vaccinations of individuals other the patient; and
determining the likelihood that the insurance claim for administration of the first vaccination to the patient would be approved based at least in part on:
the at least one characteristic of previously submitted insurance claims which were approved; and
the at least one characteristic of previously submitted insurance claims which were denied;
determining, based at least in part on the likelihood that the insurance claim for administration of the first vaccination would be approved, whether to guarantee payment to the health care provider for administering the first vaccination; and
sending an eligibility message to the provider interface, wherein the eligibility message comprises an indication of whether payment for administering the first vaccination is guaranteed for the health care provider.

2. The system for determining whether to guarantee payment to a health care provider for administering at least one vaccination to a patient of claim 1, wherein determining via the rules engine, and based at least in part on the insurance information, the likelihood that the insurance claim for administration of the first vaccination would be approved comprises:
determining, based at least in part on the insurance information, whether the patient has active insurance coverage.

3. The system for determining whether to guarantee payment to a health care provider for administering at least one vaccination to a patient of claim 2, wherein determining, based at least in part on the insurance information, whether the patient has active insurance coverage comprises:
sending a request to confirm active insurance coverage to an insurance company or other payer; and
receiving a response to the request.

4. The system for determining whether to guarantee payment to a health care provider for administering at least one vaccination to a patient of claim 1, wherein:
determining via the rules engine a likelihood that an insurance claim for administration of the first vaccination would be approved is further based at least in part on recommendations from at least one of the Food and Drug Administration or the Centers for Disease Control and Prevention.

5. The system for determining whether to guarantee payment to a health care provider for administering at least one vaccination to a patient of claim 1, wherein the at least one host computer is further for:
determining, based at least in part on the biographical information, a second vaccination that the patient should receive;
determining via the rules engine, and based at least in part on the insurance information, a likelihood that an insurance claim for administration of the second vaccination would be approved;
determining, based at least in part on the likelihood that the insurance claim for administration of the second vaccination would be approved, whether to guarantee payment to the health care provider for administering the second vaccination; and
wherein the eligibility message comprises an indication of whether payment for administering the second vaccination is guaranteed for the health care provider.

6. The system for determining whether to guarantee payment to a health care provider for administering at least one vaccination to a patient of claim 1, wherein the at least one host computer is further for:
determining via the rules engine, and based at least in part on the insurance information, an amount of the guarantee; and
wherein the eligibility message comprises an indication of the amount of the guarantee.

7. The system for determining whether to guarantee payment to a health care provider for administering at least one vaccination to a patient of claim 6, wherein the at least one host computer is further for:
determining via the rules engine, and based at least in part on the insurance information, an amount the patient is responsible for; and
wherein the eligibility message comprises an indication of the amount the patient is responsible for.

8. The system for determining whether to guarantee payment to a health care provider for administering at least one vaccination to a patient of claim 1, wherein the at least one host computer is further for:
receiving a check-out message from the provider interface, wherein the check-out message comprises an indication that the health care provider administered the first vaccine to the patient; and
causing a payment to the health care provider to be initiated based at least in part on the check-out message being received.

9. The system for determining whether to guarantee payment to a health care provider for administering at least one vaccination to a patient of claim 8, wherein the at least one host computer is further for:
sending a claim for administration of the first vaccination to a payer, wherein the claim is based at least in part on the insurance information.

10. The system for determining whether to guarantee payment to a health care provider for administering at least one vaccination to a patient of claim 9, wherein the at least one host computer is further for:
receiving a response to the claim from the payer; and
updating the rules engine based at least in part on the response.

11. A method for determining whether to guarantee payment to a health care provider for administering at least one vaccination to a patient, wherein the method comprises:
receiving a check-in message from a provider interface, wherein the check-in message comprises:
biographical information of the patient; and
insurance information of the patient;
determining, based at least in part on the biographical information, a first vaccination that the patient should receive;
determining via a rules engine, and based at least in part on the insurance information, a likelihood that an insurance claim for administration of the first vaccination would be approved, wherein determining via the rules engine the likelihood that the insurance claim for administration of the first vaccine would be approved comprises:
determining at least one characteristic of previously submitted insurance claims which were approved, at least in part, for vaccinations of individuals other than the patient;
determining at least one characteristic of previously submitted insurance claims which were denied for vaccinations of individuals other the patient; and
determining the likelihood that the insurance claim for administration of the first vaccination to the patient would be approved based at least in part on:
the at least one characteristic of previously submitted insurance claims which were approved; and
the at least one characteristic of previously submitted insurance claims which were denied;
determining, based at least in part on the likelihood that the insurance claim for administration of the first vaccination would be approved, whether to guarantee payment to the health care provider for administering the first vaccination, and an amount of the guarantee;
sending an eligibility message to the provider interface, wherein the eligibility message comprises an indication of whether payment for administering the first vaccination is guaranteed for the health care provider, and the amount of the guarantee;
receiving a check-out message from the provider interface, wherein the check-out message comprises an indication that the health care provider administered the first vaccine to the patient; and
causing a payment to the health care provider in the amount of the guarantee to be initiated based at least in part on the check-out message being received.

12. The method for determining whether to guarantee payment to a health care provider for administering at least one vaccination to a patient of claim 11, wherein:
determining the amount of the guarantee is further based at least in part on the rules engine; and
wherein the method further comprises:
sending a claim for administration of the first vaccination to a payer, wherein the claim is for the amount of the guarantee and is based at least in part on the insurance information;
receiving a response to the claim from the payer indicating a different amount than the amount of the guarantee; and
updating the rules engine based at least in part on the different amount.

13. The method for determining whether to guarantee payment to a health care provider for administering at least one vaccination to a patient of claim 11, wherein the method further comprises:
determining via the rules engine, and based at least in part on the insurance information, an amount the patient is responsible for; and
wherein the eligibility message comprises an indication of the amount the patient is responsible for.

14. The method for determining whether to guarantee payment to a health care provider for administering at least one vaccination to a patient of claim 13, wherein the method further comprises:
sending a claim for administration of the first vaccination to a payer, wherein the claim is based at least in part on the insurance information;
receiving a response to the claim from the payer; and
updating the rules engine based at least in part on the response.

15. The method for determining whether to guarantee payment to a health care provider for administering at least one vaccination to a patient of claim 13, wherein the amount the patient is responsible for is zero.

16. The method for determining whether to guarantee payment to a health care provider for administering at least one vaccination to a patient of claim 11, wherein the method further comprises:
sending a claim for administration of the first vaccination to a payer, wherein the claim is for the amount of the guarantee and is based at least in part on the insurance information;
receiving a response to the claim from the payer indicating an amount still owed by the patient; and
causing the patient to be notified of the amount still owed by the patient.

17. The method for determining whether to guarantee payment to a health care provider for administering at least one vaccination to a patient of claim 16, wherein the method further comprises:
causing a payment from the patient to be initiated for the amount still owed by the patient; and
causing a payment to the payer or health care provider to be initiated for the amount still owed by the patient.

18. A non-transitory machine readable medium having instructions stored thereon for determining whether to guarantee payment to a health care provider for administering at least one vaccination to a patient, the instructions executable by a processor for at least:
receiving a check-in message from a provider interface, wherein the check-in message comprises:
biographical information of the patient; and
insurance information of the patient;
determining, based at least in part on the biographical information, a first vaccination that the patient should receive;
determining via a rules engine, and based at least in part on the insurance information, a likelihood that an insurance claim for administration of the first vaccination would be approved, wherein determining via the rules engine the likelihood that the insurance claim for administration of the first vaccine would be approved comprises:
determining at least one characteristic of previously submitted insurance claims which were approved, at least in part, for vaccinations of individuals other than the patient;
determining at least one characteristic of previously submitted insurance claims which were denied for vaccinations of individuals other the patient; and
determining the likelihood that the insurance claim for administration of the first vaccination to the patient would be approved based at least in part on:
the at least one characteristic of previously submitted insurance claims which were approved; and
the at least one characteristic of previously submitted insurance claims which were denied;
determining, based at least in part on the likelihood that the insurance claim for administration of the first vaccination would be approved, whether to guarantee payment to the health care provider for administering the first vaccination;
sending an eligibility message to the provider interface, wherein the eligibility message comprises an indication of whether payment for administering the first vaccination is guaranteed for the health care provider;
receiving a check-out message from the provider interface, wherein the check-out message comprises an indication that the health care provider administered the first vaccine to the patient; and
updating a stock of a first vaccine corresponding with the first vaccination in a virtual inventory of the health care provider based at least in part on the check-out message.

19. The non-transitory machine readable medium of claim 18, wherein the instructions are further executable by the processor for at least:
determining the stock of the first vaccine in the virtual inventory is equal to, or less than, a predefined threshold; and
based on the determination that the stock of the first vaccine in the virtual inventory is equal to, or less than, the predefined threshold, causing an order to be placed for additional first vaccines to be delivered to the health care provider.

20. The non-transitory machine readable medium of claim 18, wherein the instructions are further executable by the processor for at least:
predicting changes in the stock of the first vaccine in the virtual inventory; and
based on the predicted changes, causing an order to be placed for additional first vaccines to be delivered to the health care provider prior to a predefined threshold being reached by the stock of the first vaccine in the virtual inventory.

21. The non-transitory machine readable medium of claim 20, wherein predicting changes in the stock of the first vaccine in the virtual inventory is based on at least one selection from a group consisting of:
historical usage of the first vaccine;
current time of year; and
a total population of patients of the health care provider.

22. The non-transitory machine readable medium of claim 18, wherein the instructions are further executable by the processor for at least:
accessing a database of patients of the health care provider;
determining a plurality of the patients should receive at least one vaccination based at least in part on biographical information of each of the plurality of patients.

23. The non-transitory machine readable medium of claim 22, wherein the instructions are further executable by the processor for at least:
causing a message to be sent to each of the plurality of patients.
